(19) United States
(12) Patent Application Publication
(10) Pub. No.: US 2006/0173692 A1
(43) Pub. Date: Aug. 3, 2006

(54) Audio compression using repetitive structures

(76) Inventors: Vishweshwara M. Rao, Mumbai (IN); Kenneth C. Pohlmann, South Miami, FL (US)

Correspondence Address: Steven M. Greenberg;Christopher & Weisberg, P.A., Suite 2040, 200 East Las Olas Boulevard, Fort Lauderdale, FL, 33301, US

(21) Appl. No.: 11/049,814

(22) Filed: Feb. 3, 2005

(51) Int. Cl. G10L 21/04

(52) U.S. Cl. 704/503

(57) ABSTRACT

A system, apparatus and method for compressing audio by detecting and processing repetitive structures in the audio. In this regard, a system has a repetition detector that is configured to detect repetitive structures in input audio signals or files, and then generates repetition data related to the input audio, which an encoder will process and compress. For several types of audio signal or files, the system can further include a beat tracking detector to increase the efficiency of the repetition detector by calculating frame and segment length to be a submultiple of the beat of an audio file, such as music.

### FIELD OF THE INVENTION

The present invention relates generally to data compression and decompression and, more particularly to systems, methods and apparatuses for providing audio data compression and decompression using structural or compositional redundancies.

### BACKGROUND OF THE INVENTION

The Internet is one of the most widely used media for the distribution of music. Downloading music from the Internet may replace the audio CD. However, the increasing popularity of the Internet as a music distribution mechanism is accompanied by the fact that large bandwidth, required for high-speed transmission, is not yet available to all users. This brings about the need for music compression techniques that can compress digitally stored music so that it can be transmitted over low-bandwidth connections in a reasonable amount of time. In general, data compression is defined as storing data in a manner that requires less space than usual. Data compression is widely used to reduce the amount of data required to process, transmit, store and/or retrieve a given quantity of information. In general, there are two types of data compression techniques that may be utilized either separately or jointly to encode and decode data: lossy and lossless data compression.

Lossy data compression techniques provide for an inexact representation of the original uncompressed data such that the decoded (or reconstructed) data differs from the original unencoded/uncompressed data. Lossy data compression is also known as irreversible or noisy compression. Many lossy data compression techniques seek to exploit various traits within the human senses to eliminate otherwise imperceptible data. For example, if a loud and soft sound occur simultaneously, the human ear might not be able to hear the soft sound at all and so, based on the information output from the psychoacoustic model, the encoder might choose to ignore it.

On the other hand, lossless data compression techniques provide an exact representation of the original uncompressed data. Simply stated, the decoded (or reconstructed) data is identical to the original unencoded/uncompressed data. Lossless data compression is also known as reversible or noiseless compression.

Although lossless data compression techniques (coders) make use of statistically redundant information and lossy data compression techniques (coders) make use of perceptually redundant information in audio, neither technique makes use of the structural redundancies in audio (for example, most music is made of repetitive structures). It is desirable to gain additional compression of audio files in order to further reduce processing time and storage of information, as well as decrease transmission times for these files over various data connections.

### SUMMARY OF THE INVENTION

The present invention advantageously provides a system, apparatus and method for compressing audio signals by using repetitive structures. In this regard, the system has a repetition detector that is configured to detect repetitive structures in input audio signals or files, and then generate repetition information related to the input files, which an encoder can process and compress based on the repetition data generated by the repetition detector. For several types of audio files, the system can further include a beat tracking detector to increase the efficiency of the repetition detector by calculating frame and segment length to be a submultiple of the beat of an audio file, such as music.

An audio compression method can include the step of detecting structurally redundant data in portions of an audio signal or file that have similarly repetitive content, generating repetition data for the detected structurally redundant data, and then encoding an audio file utilizing the generated repetition data. The detecting step may include dividing the input audio signal or file into equal-length frames, extracting at least one feature vector from the equal-length frames to parameterize each equal-length frame, constructing a similarity matrix of the extracted at least one feature vector, detecting points of significant change in the equal-length frames to further divide the equal-length frames into sections, and applying template matching to detect repetition of the sections of the input audio file.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are particular examples, it being understood, however, that the invention is not limited to the precise arrangements and instrumentalities shown, wherein:

FIG. 1 is a schematic diagram illustrating a system configured for audio file compression in accordance with an embodiment of the present invention; and,

FIG. 2 is a flow chart illustrating a process for audio file compression in the system of FIG. 1.

### DETAILED DESCRIPTION OF THE INVENTION

The present invention is a method, system and apparatus for audio compression. In accordance with the present invention, an input audio signal can be received and processed by a repetition detector. In general, the repetition detector can process the audio by dividing the input audio signal into equal length frames based upon a selected frame size. This is typically referred to as segmentation. Alternatively the frame length can be determined by using an automatic process that can calculate a frame length based on the particular audio file type. The automatic process can include, by way of example, a beat detector that calculates a beat-synchronous frame size for an audio file. Once the input audio signal has been divided into equal frames, extracting or computing a set of feature vectors for each frame parameterizes it. The feature vectors are then used to build a “similarity matrix.” The purpose of the similarity matrix is to display the similarity between a frame of the audio (e.g., song) and all the other frames of the audio (e.g., song). The similarity matrix data is used to identify the locations of any repeated segments of the audio file and processed by the Repetition Detector to generate repetition data for input to the Encoder.

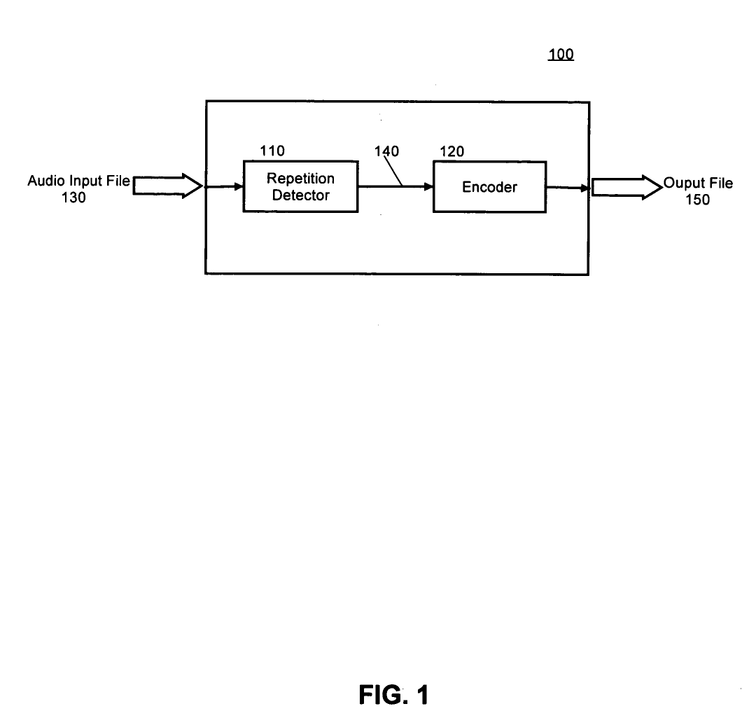

In further illustration of a particular aspect of the present invention, FIG. 1 is a schematic diagram illustrating a system configured for audio compression in accordance with an embodiment of the present invention. The system can include a Repetition Detector 110 coupled to an Encoder 120. An Input Audio Signal 130 is provided at the input of the Repetition Detector 110. The Input Audio Signal 130 may reside on various databases accessible via a computer communications network, for instance the global Internet.

The Repetition Detector 110 can process the Input Audio Signal 130 to determine the structural or compositional redundancies contained within the Input Audio Signal 130. The Repetition Detector 110 can then provide Repetition Data 140 for an Input Audio Signal 130 to the Encoder 120. The Repetition Data 140 generated by the Repetition Detector 110 can include the information shown in Table 1, below:

TABLE 1
Repetition Data Passed to the Encoder From the Repetition Detector

| | | | | | |
|---|---|---|---|---|---|
| Segment | Length of | Start Time | Number of | Repetition | Repetition |
| Number | Segment | | Repetitions | Start Time | Flag |

In Table 1, the Segment Number is an index of all the different distinct segments that have been detected within the Input Audio Signal 130. The Length of Segment and its Start Time are indicated in sample numbers but may be represented in time format. Also passed to the Encoder 120, is the Number of Repetitions of each segment along with the corresponding Repetition Start Times for each segment. The Repetition Flag is an indicator of whether the segment in consideration has appeared at any prior location in the Input Audio Signal 130. The Repetition Flag is set to “0” if the segment has not appeared before, and set to “1 ” if the segment has appeared at some prior location in the Input Audio Signal 130.

The Encoder 120 can work in both lossy and lossless modes. In the lossy mode the Encoder 120 will not consider subtle differences between repeated sections. If a section is repeated, then its repetitions will be exact renditions of the first segment. No difference frame is calculated between repeated segments. This will result in a greater degree of compression; however, every repetition of the reconstructed song at the decoder will be an exact copy of its first occurrence. This could result in a loss of aesthetic quality of the song. For example, minor changes in the performer's rendition of a repeated chorus will be lost. The minor changes may include anticipation, syncopation, swing, a change in lyrics, a slight change in the melody and other similar changes. In the lossless mode however, a difference frame between each repetition and its first occurrence is also encoded along in the bit-stream. Therefore, the decoder is able to regenerate the original audio signal without losing the differences in the repetitions of different sections of a song. As a result of encoding extra data (e.g., the difference frame for each repetition), the compression ratios achieved in lossless coding should be lower than those achieved in lossy coding.

It should be noted that the term “lossy” as used herein is different from the context in which it is used for describing perceptual coding. Perceptual coding is called lossy because all superfluous information from the audio has been removed. More precisely, the psychoacoustically redundant and irrelevant parts of the audio signal have been eliminated. Thus, although an audio file encoded by a perceptual coder will be statistically lossy, it might be perceivably lossless i.e., the listener might not hear the differences between the original and encoded versions of the audio file, depending upon the degree of compression, even though a significant amount of data is discarded during the encoding process.

In this application, however, “lossy” is used in an aesthetic context. The Encoder 120 will perform a “cut and paste” type operation on repeated sections of an audio file i.e., so repetitions of a section will be exact copies of that section. Consequently, subtle differences between repetitions might be lost. However, the encoded segment itself is completely lossless, i.e., the segment that is encoded is an exact replica of its occurrence in the original audio file. Enhancing compression by further perceptual coding of encoded segments of audio is possible in both, the lossy and lossless, options of the Encoder 120. This means that the compression ratios achieved by this system 100 act as multipliers to compression ratios achieved by perceptual coding systems.

As an example, if a perceptual coder is able to achieve a compression ratio of 10:1 (e.g., perceptual coders such as MP3 and AAC are known to achieve size reduction by a factor of 10-12 with little or no perceptible loss of quality), and the coder proposed in this paper was able to compress (either in a lossy or lossless mode) the audio file by a ratio of 2:1, then a combination of the two systems would theoretically be able to achieve a compression ratio of 20:1, which is quite substantial.

In both the lossy and lossless modes the encoder will first code a header as shown in Table 2, below:

TABLE 2
Header Bit-Stream for Repetition Data

| | | | |
|---|---|---|---|
| Length of Song | Sampling Frequency | Bits/Sample | Lossy/lossless flag |

In Table 2, the length of the song being encoded is provided in the Length of Song portion of the Header. The sampling frequency size and the number of bits per sample are provided in the Sampling Frequency and Bits/Sample portions of the Header, respectively. The lossy/lossless flag is used to indicate the type of encoding (lossy or lossless). A flag value of 0 indicates lossy coding while a flag value of 1 indicates lossless coding. This information is required to regenerate the Input Audio Signal 130.

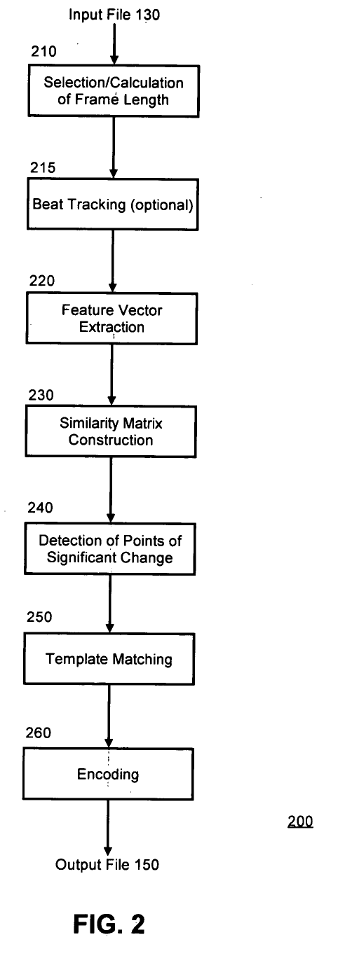

In a more specific illustration of the Repetition Detector 110, FIG. 2 is a flowchart illustrating a process for audio file compression in the system of FIG. 1. Beginning in block 210, a frame (or window) length is selected or alternatively, calculated to be some value, and a portion of an audio input signal 130 equal to the frame length is selected. At this time, an optional beat tracking step 215 may be executed to calculate a beat synchronous frame length to be a submultiple of the beat of the audio input signal 130.

Once the audio signal 130 has been divided into frames of equal length, computing a set of feature vectors for each frame parameterizes it. This is accomplished in step 220, Feature Vector Extraction. For example, in one embodiment, the features extracted may be Fundamental Frequency (Pitch), Mel-Frequency Cepstral Coefficients (MFCC), a Chroma vector and Critical Band Scale Rate. The choice of using one or more of these features is up to the designer. The actual parameterization is not crucial as long as “similar” sounds yield similar parameters. Repetitive structures are detected based on a similarity rating between the feature vectors of different frames of the audio signal. As long as “similar” frames yield similar parameters, similarity is detected and subsequently, so is structural redundancy. For each frame of the audio signal, some feature vectors are extracted that might not depend on the spectral properties of the audio signal within the frame.

There can be different definitions of “similar” sounds. Sounds can be acoustically similar based on physical properties. Sounds can have the same values of dynamic range, which is a measure of similarity in the time-domain. Spectral features of sound can also be used to judge similarity. Furthermore, similarity judgments of human listeners can be characterized using psycho-acoustically based parameterization. Different parameterizations may be very useful for different applications. For example, for retrieving songs in a database that are perceptually similar to a particular song, it would be useful to use psycho-acoustically based feature such as Critical Band Scale Rate. To detect similar-sounding voices, it would be practical to use a feature that characterizes human voices such as Mel-Frequency Cepstral Coefficients.

Once the feature vectors have been extracted from the segmented audio, the vectors may be placed into a two-dimensional representation called the Similarity Matrix. The concept of the Similarity Matrix is to visualize the structure of music by its similarity or dissimilarity in time, rather than absolute characteristics or note events. In block 230, the construction of the Similarity Matrix is performed, and the generated Similarity Matrix is provided to block 240, for Detection of Points of Significant Change.

Points of audio novelty in music or audio are defined as points of significant change in the song, such as individual note boundaries and natural segment boundaries such as verse/chorus transitions. In video, the frame-to-frame difference is often used as a measure of novelty. However, computing audio novelty is significantly more difficult than video. Straightforward spectral differences are not useful because they give too many false positives. Typical music spectra constantly fluctuate, and it is not a simple task to discriminate significant changes from ordinary variation.

The Detection of Points of Significant Change 240 provides for the extraction of segment boundaries within the Audio Input File 130. The extracted segment boundaries allow for the division of the song into segments. In order to find repetitions of a particular segment, the segment's similarity matrix representation is used as a template. For each segment, there is one template that corresponds to that segment's location in the similarity matrix.

In block 250, Template Matching is performed using the segment boundaries detected in block 240. For example, sliding a template horizontally, to the end of the song, and summing the element-by-element product of the template and that part of the song may perform the correlation part of Template Matching 250. Correlating the template with the rest of the similarity matrix (in the same horizontal alignment with the segment itself) results in a sequence of correlation values at each instant after the segment. Correlation with the remaining part of the song is performed for each segment using itself as a template. If the template of each segment were shifted by a single frame every time correlation were performed, this output would result in a correlation matrix having the number of rows equal to the number of segments detected and the number of columns equal to the number of frames in the audio. However, such an output would be computationally expensive, therefore, in the present process, only correlating between or among equal size segments performs the correlation.

Each row of the correlation matrix is representative of how similar the segment is to the rest of the song. Peaks in that particular row of the correlation matrix will characterize repetitions of the segment. To detect peaks in the correlation matrix, all values of the matrix below a particular threshold value are set to zero to avoid detection of false peaks. If one were performing normal correlation, then setting a value of the threshold would be a problem because similar segments having low energy would have small peaks and similar segments having higher energy would have large peaks.

This problem is overcome by normalizing the correlation matrix by dividing by the energy over the template itself. Since the similarity matrix only contains the values between 1 (indicating high similarity) and −1 (indicating low similarity), this simply involves summing all the elements of the template. Normalizing the correlation causes all values in the correlation matrix to lie between 0 and 1.

After the template matching process is performed, a generation of repetition data step (not shown) is performed on the detected structurally redundant data. That is, Repetition Data 140 is provided for each segment, including information about its length, start time, end time, number of repetitions (if any), locations of detected repetitions and information whether it has already been repeated before. Information of previous repetition of a particular segment is stored in terms of a flag called as the repetition flag. If a repetition of a segment is detected then the repeated segment is marked with a value of 1 for the repetition flag, indicating that it has appeared previously in the audio. Otherwise it is set to zero for the segment. Repetition Data is generated from this segmentation and repetition information is passed to the Encoding step 260 for actual compression of the audio file 130.

In the Encoding step 260, the Encoder 120 may compress the audio file 130 in either a lossy or lossless compression mode as described above. The Output 150 (compressed file) of the Encoder 120 can now be stored or transmitted to numerous systems and users.

Although the Encoder and the Repetition Detector are shown as separate components, they can be integrated into a single component or separated out into multiple components. Similarly, the different modules of the compression system can be performed on portions of the audio file instead of the whole audio file, and can be integrated in various combinations.

In the exemplary embodiments above, the encoding and decoding is performed in the time domain. However, this process is prone to errors. A few samples shifted either way could cause the repeated segments to misalign with each other and cause coding errors. Another way to encode the data is through transform coding.

In transform coding, a block of time-domain samples is converted to the frequency domain. Coders can use transforms such as the Discrete Fourier Transform (DFT) implemented using the Fast Fourier Transform (FFT) or the Modified Discrete Cosine Transform (MDCT). The spectral coefficients output by the transform are quantized according to a psychoacoustic model; masked components are eliminated and quantization decisions are based on audibility. Fundamentally, a transform coder encodes frequency coefficients. The coefficients are grouped into about 32 bands that emulate critical band analysis. The frequency coefficients in each band are quantized according to the information output by the encoder's psychoacoustic model.

A system that combined repetition coding along with transform coding would work by first detecting repetitions in music. Then, instead of encoding each segment in the time domain, it would perceptually encode each segment along with the repetition information of that segment. Integrating a transform coder with repetition based coding would combine the advantages of psychoacoustic masking effects and structural redundancy in music to enhance overall compression. In most types of music, this form of lossy coding would provide a greater compression ratio than a stand-alone perceptual coder.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A system for compressing audio, the system comprising:
a repetition detector configured to detect repetitive structures in audio and to generate repetition data for detected repetitive structures; and,
an encoder coupled to said repetition detector and programmed to encode an audio file utilizing generated repetition data.

2. The system of claim 1, wherein said repetition detector comprises a beat tracking detector programmed to calculate a beat synchronous frame size in said audio when detecting said repetitive structures.

3. An audio compression method comprising the steps of:
detecting structurally redundant data in portions of an audio signal having similarly repetitive content;
generating repetition data for said detected structurally redundant data; and, encoding an audio file utilizing said generated repetition data.

4. The method of claim 3, further comprising the step of determining a frame size for said audio signal by applying a beat tracking process.

5. The method of claim 3, wherein said detecting step comprises the steps of:
dividing said audio signal into equal-length frames;
extracting at least one feature vector from said equal-length frames to parameterize each said equal-length frame;
constructing a similarity matrix of said extracted at least one feature vector;
detecting points of significant change in said equal-length frames to further divide the equal-length frames into sections; and
applying template matching to detect repetition of said sections of said input audio file.

6. The method of claim 3, wherein said audio signal is a lossless encoded file.

7. The method of claim 3, wherein said audio signal is a lossy encoded file.

8. The method of claim 3, wherein said encoding step is performed in a lossless mode.

9. The method of claim 3, wherein said encoding step is performed in a lossy mode.

10. A machine readable storage having stored thereon a computer program for compressing audio files, the computer program comprising a routine set of instructions which when executed by a machine causes the machine to perform the step of detecting structurally redundant data in portions of an audio signal having similarly repetitive content, generating repetition data for said detected structurally redundant data, and encoding an audio file utilizing said generated repetition data.

11. The machine-readable storage of claim 10, wherein said detecting step comprises the steps of:
dividing said audio signal into equal-length frames;
extracting at least one feature vector from said equal-length frames to parameterize each said equal-length frame;
constructing a similarity matrix of said extracted at least one feature vector;
detecting points of significant change in said equal-length frames to further divide the equal-length frames into sections; and
applying template matching to detect repetition of said sections of said input audio file.

12. The machine-readable storage of claim 10, wherein said audio signal is a lossless encoded file.

13. The machine-readable storage of claim 10, wherein said audio signal is a lossy encoded file.

14. The machine-readable storage of claim 10, wherein said encoding step is performed in a lossless mode.

15. The machine-readable storage of claim 10, wherein said encoding step is performed in a lossless mode.
